(19) United States
(12) Patent Application Publication
(10) Pub. No.: US 2008/0002306 A1
(43) Pub. Date: Jan. 3, 2008

(54) Magnetic head

(75) Inventors: Mitsuru Otagiri, Kawasaki (JP); Hideyuki Akimoto, Kawasaki (JP); Masaya Kato, Kawasaki (JP); Hiroshi Shirataki, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 11/516,938

(22) Filed: Sep. 7, 2006

(30) Foreign Application Priority Data
Jun. 28, 2006 (JP) 2006-178013

(51) Int. Cl. G11B 5/33

(52) U.S. Cl. 360/319

(57) ABSTRACT

The magnetic head is capable of preventing variation of magnetic fields working to a read-element, stably generating output signals and improving production yield. The magnetic head comprises: a read-head including a read-element; and a shield for magnetic-shielding the read-element, the shield has a hexagonal planar shape, and one side of the shield is flush with an air bearing surface of the magnetic head.

### BACKGROUND OF THE INVENTION

The present invention relates to a magnetic head, more precisely relates to a magnetic head, which has a unique shield and which is capable of restraining variation of output signals from a read-head and boosting yield.

FIG. 7 shows a positional relationship between a recording medium 5 and a read-head of a conventional magnetic head, which is reading magnetic data from the recording medium 5. The read-head has a read-element 10, which is sandwiched between a lower shield 12 and an upper shield 14. The lower and upper shields 12 and 14 are soft magnetic films. End faces of the lower and upper shields 12 and 14 are arranged to face a recording surface of the recording medium 5, so that recorded data can be read by the read-element 10. The lower and upper shields 12 and 14 magnetically shield the read-element 10, so that the read-element 10 is capable of sensing data, which are recorded immediately below the read-element 10, with high resolution. The lower and upper shields 12 and 14 usually have rectangular planar shapes or square planar shapes.

FIG. 9 shows a schematic view of the read-element 10 seen from an air bearing surface side. The read-element 10 is sandwiched between the lower and upper shields 12 and 14 with an insulating layer, and terminals 22 are respectively provided to the both sides of the read-element 10.

The shown read-element 10 is a spin-valve type giant magnetoresistance (GMR) element. The GMR element is constituted by a plurality of magnetic and nonmagnetic layers. The layers are layered from the bottom as an antiferromagnetic layer 101/a pin layer 102/a free layer 103/a cap layer 104. The antiferromagnetic layer 101 antiferromagnetically couples with the pin layer 102 so as to fix a magnetizing direction in a height-direction of the element. The free layer 103 freely changes its magnetizing direction on the basis of magnetic data recorded in the medium. A GMR effect, which changes resistance, depends on an angle between the magnetizing directions of the pin layer 102 and the free layer 103; the magnetic data can be detected, from the medium, as variation of the resistance.

In the conventional spin-valve type magnetoresistance effect element, hard films 20, which are made of a permanent magnet material having a relatively great coercive force, are respectively provided on the both sides of the read-element, and the magnetizing direction of the free layer 103 is oriented in the core-width direction (in the right-and-left direction in the drawing) when no external magnetic field works. Therefore, reproducing efficiency can be maximized, and a symmetric property of reproduced output signals can be secured.

In a production process of the magnetic head, a strong magnetic field of several kOe is applied in the core-width direction so as to orient magnetization directions of the hard films 20 in the magnetizing direction of the magnetic field. In this magnetizing step, magnetic layers of the magnetic head are magnetized in the magnetizing direction. However, their magnetization directions are varied when the magnetic field is disappeared. Namely, the magnetization directions of the hard films are almost the same as the magnetizing direction; the magnetization direction of the free layer is almost the same as the magnetizing direction due to bias magnetic fields of the hard films; and the magnetization direction of the pin layer is oriented in the height direction of the element, without reference to the magnetizing direction, due to the antiferromagnetic coupling with the antiferromagnetic layer 101.

On the other hand, the lower and the upper shields 12 and 14 are made of a soft magnetic material having a relatively small coercive force, so their magnetic patterns have a structure for minimizing static magnetic energies. Namely, the entire shield has a magnetic domain structure, in which a macroscopic magnetization of the entire shield is near zero. The conventional rectangular or square shield is divided into four magnetic domains (see FIGS. 8A and 8B) or seven magnetic domains (see FIG. 8C). Note that, even if shields have the same shapes, the magnetic domain structure is changed from seven-domain structure to four-domain structure by a magnetizing process, and vice versa.

By the way, a width and a height of the shield is several dozen μm. On the other hand, a width and a height of the read-element is, for example, about 100 nm, so they are much smaller than those of the shield, i.e., from one-1000th to a one-several hundredth. Therefore, the read-element is badly influenced by the magnetization of the upper shield 14. Especially, in the spin-valve type GMR element, the terminals 22 are provided to the both sides of the element, so asperities are formed in the side face of the upper shield 14 facing the element. With the asperities, great leakage magnetic fields are generated from the projected parts of the asperities.

Directions of the leakage magnetic fields are the same as the magnetization direction of the shield in the vicinity of the element. The magnetic fields shown in FIGS. 10A and 10B, which respectively correspond to the magnetic domain structure shown in FIGS. 8A and 8B, work. In FIG. 10A, the magnetic field works in the direction equal to the magnetization direction of the hard films 20; in FIG. 10B, the magnetic field works in the opposite direction of the magnetization direction of the hard films 20.

According to an experiment, in case of having seven magnetic domains shown in FIG. 8C, the magnetization direction of the shield was uniquely defined after disappearing the magnetizing field. On the other hand, in case of having four magnetic domains as shown in FIGS. 8A and 8B, clockwise magnetic domain structures and counterclockwise magnetic domain structures are formed with the same probability after disappearing the magnetizing field. Therefore, intensities of a bias magnetic field working to the read-element, which is a resultant magnetic field of the magnetic fields generated by the hard films 20 and the projected parts of the upper shield, was varied on the basis of the clockwise or counterclockwise magnetic domain structure after disappearing the magnetizing field. As the result of the variation, output signals of the read-element were also varied.

| | |
|---|---|
| Patent Document 1 | Japanese Patent Gazette No. 2001-229515 |
| Patent Document 2 | Japanese Patent Gazette No. 2005-353666 |

### SUMMARY OF THE INVENTION

The present invention was conceived to solve the problems: the variation of the magnetic domain structure of the upper shield, the variation of output signals of the read-element and descent of production yield of magnetic heads.

An object of the present invention is to provide a magnetic head, which is capable of preventing variation of magnetic fields working to a read-element, stably generating output signals and improving production yield.

Another object is to provide a magnetic disk drive unit having the magnetic head of the present invention.

To achieve the objects, the present invention has following structures.

Namely, the magnetic head of the present invention comprises: a read-head including a read-element; and a shield for magnetic-shielding the read-element, the shield has a hexagonal planar shape, and one side of the shield is flush with an air bearing surface of the magnetic head.

Note that, one or both of a lower shield and an upper shield, which sandwich the read-element as the shield, may have the hexagonal planar shapes.

In the magnetic head, the shield may be line-symmetrically formed in a core-width direction with respect to a position of the read-element. Further, the shield may be line-symmetrically formed in a height direction. By line-symmetrically forming the shield, a stable magnetic domain structure can be effectively produced.

Preferably, inner angles of corner sections, which are respectively formed in both side faces in a core-width direction, are 170 degrees or less.

Another magnetic head comprises: a read-head including a read-element; and a shield for magnetic-shielding the read-element, the shield has a triangular planar shape, and one side of the shield is flush with an air bearing surface of the magnetic head.

In the magnetic head, the shield may be line-symmetrically formed in a core-width direction with respect to a position of the read-element.

The magnetic disk drive unit of the present invention comprises the magnetic head of the present invention. By using the magnetic head of the present invention, the magnetic disk drive unit, which has excellent reproduction characteristics, can be produced.

In the present invention, the shield has the hexagonal or triangular planar shape, so that a magnetic domain structure, which is produced in the shield after the magnetizing step, can be stable and a magnetization direction of a magnetic domain can be uniquely defined with respect to a magnetizing direction. Therefore, variation of output signals of the read-element can be restrained, and the magnetic head having stable characteristics can be realized. Further, by restraining variation of quality, production yield of the magnetic head can be improved.

### BRIEF DESCRIPTION OF THE DRAWINGS

Embodiments of the present invention will now be described by way of examples and with reference to the accompanying drawings, in which:

FIG. 1A is a plan view of shields of a magnetic head of a first embodiment of the present invention;

FIG. 1B is a perspective view of the shields thereof;

FIGS. 2A and 2B are explanation views showing magnetic domains and a magnetizing direction of the shields of the first embodiment;

FIG. 3A is a plan view of the shields of a second embodiment;

FIG. 3B is a perspective view of the shields thereof;

FIGS. 4A and 4B are explanation views showing magnetic domains and a magnetizing direction of the shields of the second embodiment;

FIG. 5 is a plan view of a magnetic disk drive unit including the magnetic head of the present invention;

FIG. 6 is a perspective view of a head slider;

FIG. 7 is an explanation view showing the positional relationship between the recording medium and the read-head of the conventional magnetic head;

FIGS. 8A-8C are explanation views of the magnetic domain structure of the conventional shields;

FIG. 9 is a schematic view showing the read-element and the shields; and

FIGS. 10A and 10B are explanation views showing the magnetization direction of the shields in the vicinity of the read-element.

### DETAILED DESCRIPTION OF THE EMBODIMENTS

Preferred embodiments of the present invention will now be described in detail with reference to the accompanying drawings.

The magnetic head of the present invention is characterized by a shape of shields (an upper shield and a lower shield), which are formed in a read-head. Other elements of the magnetic head, e.g., a read-element, a write-head, are the same as elements included in the conventional magnetic head. Therefore, the shields of a read-head will be explained in the following description.

### First Embodiment

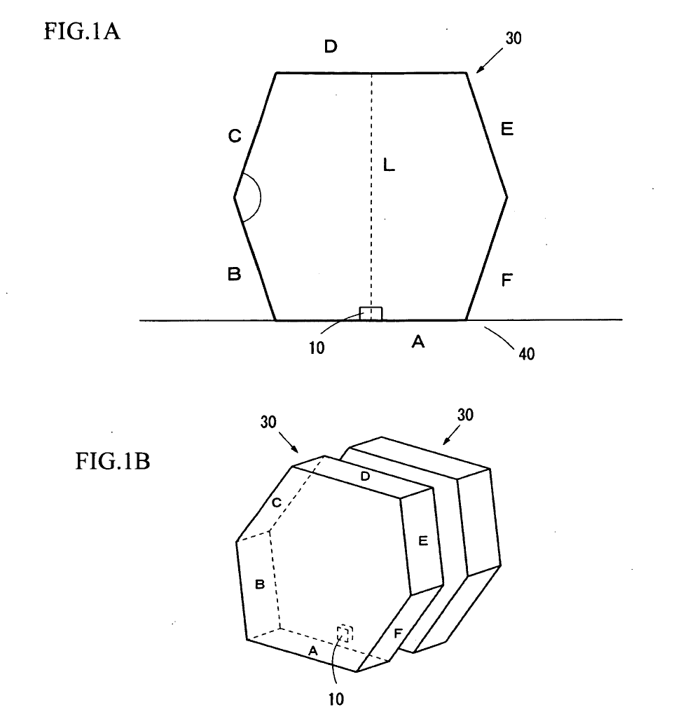

FIG. 1A is a plan view of shields of a magnetic head, and FIG. 1B is a perspective view of the shields. In the present embodiment, the shields 30 are characterized by hexagonal planar shapes. As shown in FIG. 1A, one side “A” of each hexagonal shield 30 is flush with an air bearing surface 40 of the magnetic head. Each of the shields 30 is symmetrically formed in the right-and-left direction (in the core-width direction) with respect to a center line “L” of a read-element 10. The hexagonal shield 30 has six sides “A”, “B”, “C”, “D”, “E” and “F”. The sides “A” and “D” are parallel to the air bearing surface 40. The shield 30 is symmetrically formed, in the vertical direction (in the height direction), with respect to a straight line, which connects one corner section between the sides “B” and “C” and another corner section between the sides “E” and “F”. The corner section between the sides “B” and “C” and the corner section between the sides “E” and “F” are respectively formed in both side faces in the core-width direction and convexes outward.

In FIG. 1B, the read-element 10 is sandwiched between a pair of shields 30. The shields 30 are made of a soft magnetic material, e.g., NiFe, and have a prescribed thickness. Actually, the shields 30 are short hexagonal columns.

In case of forming the shields 30 by electrolytic plating, firstly photoresist is applied to a surface of a work piece, then the photoresist is patterned so as to form hexagonal cavities in specific areas, in which the shields 30 will be respectively formed. Finally, the hexagonal cavities are filled with a magnetic material by plating. The planar shapes of the shields 30 may be optionally selected by optionally patterning the photoresist. The conventional rectangular shields are formed by patterning the photoresist to form rectangular cavities. Therefore, the hexagonal shields 30 can be formed, by the conventional method, without additional steps. The magnetic layers of the magnetic material may be formed by sputtering, etc.

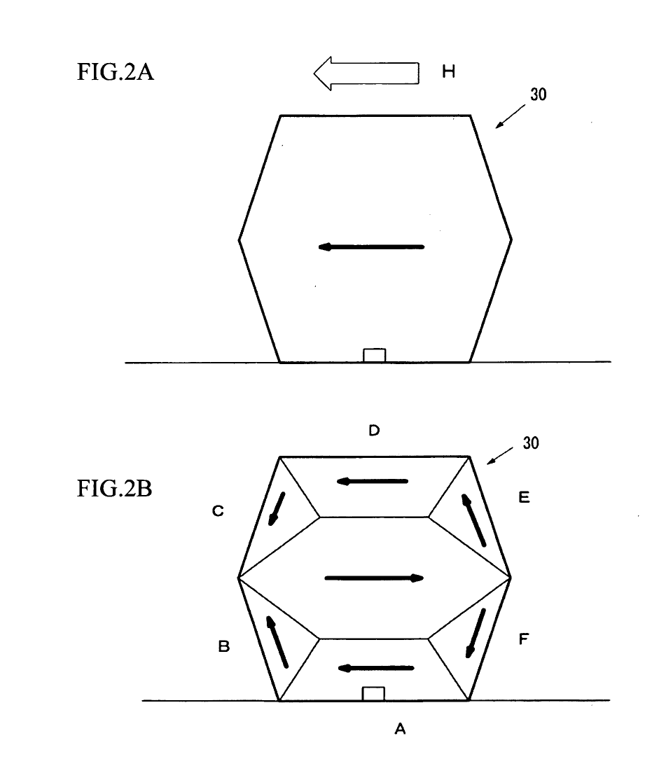

In FIG. 2A, a magnetic field “H” is applied to the shield 30 shown in FIG. 1 for magnetization; in FIG. 2B, the magnetic field is disappeared. The magnetic field “H” is applied in the core-width direction and in parallel to a surface of the shield 30.

As shown in FIG. 2A, by applying the magnetic field “H” to the shield 30, the shield 30 is magnetized in the same direction and has a single magnetic domain. When the magnetic field “H” is disappeared, the shield has a seven-domain structure as shown in FIG. 2B. In a magnetic layer, when magnetic domains are formed, the magnetic walls are formed in corner sections of the layer. In the present embodiment, the shield 30 has the hexagonal planar shape, and the magnetic walls are formed at apexes of the side faces of the shield 30 so that the shield 30 has the seven-domain structure.

Since the shield 30 are line-symmetrically formed in the core-width direction and the height direction, the magnetic domains of the shield 30 are line-symmetrically arranged in the core-width direction and the height direction. Magnetization directions of the magnetic domains constitute a reflux magnetic domain structure via the central magnetic domain. Therefore, the magnetic walls are arranged to minimize static magnetic energy of the entire shield 30.

According to an experiment, in case of the seven-domain structure shown in FIG. 2B, the magnetization directions of the magnetic domains of the shield 30 were uniquely defined by the magnetizing direction. Namely, in case of the seven-domain structure, the central magnetic domain of the shield 30 was magnetized in the direction opposite to the magnetizing direction, i.e., rightward. The magnetic domain corresponding to the read-element 10 was magnetized in the magnetizing direction.

In FIG. 2A, the magnetizing direction is leftward, but it may be rightward. In case of magnetizing rightward, the central magnetic domain of the shield 30 is magnetized rightward. In this case too, the magnetic domain corresponding to the read-element 10 is magnetized in the magnetizing direction.

In the present embodiment, the shields 30 have the hexagonal planar shapes, so that the magnetic domain structures of the shields 30 can be stabilized as the seven-domain structures when the magnetizing field working to the shields 30 is disappeared. Further, the magnetization directions of the magnetic domains, which work to the read-element 10, can be uniquely defined.

By uniquely defining the magnetic domains and the magnetization directions of the shields 30, directions of leakage magnetic fields, which leak from the shields 30 and work to the read-element 10, can be fixed. Therefore, variation of a bias magnetic field working to the read-element 10 can be prevented, characteristics of the magnetic head can be stabilized and production yield of the magnetic head can be improved.

To compulsorily form the shields 30 into the seven-domain structures, the shields 30 have the hexagonal planar shapes. In each of the shields 30, inner angles of a corner section between sides “B” and “C” and a corner section between the sides “E” and “F” are defined so as to induce magnetic walls. Preferably, the inner angles of the corner sections, which are angles between the sides “B” and “C” and between the sides “E” and “F”, are 170 degrees or less.

The shields 30 may be asymmetrically formed in the height direction and the core-width direction, but the shields 30 symmetrically formed have excellent characteristics.

In FIG. 1B, both of the shields 30 are formed into the hexagonal shapes, but the present invention is not limited to the present embodiment. For example, one of the shields 30 may be formed into the hexagonal shape, and the other shield 30 may be formed into other shapes, e.g., rectangular shape.

### Second Embodiment

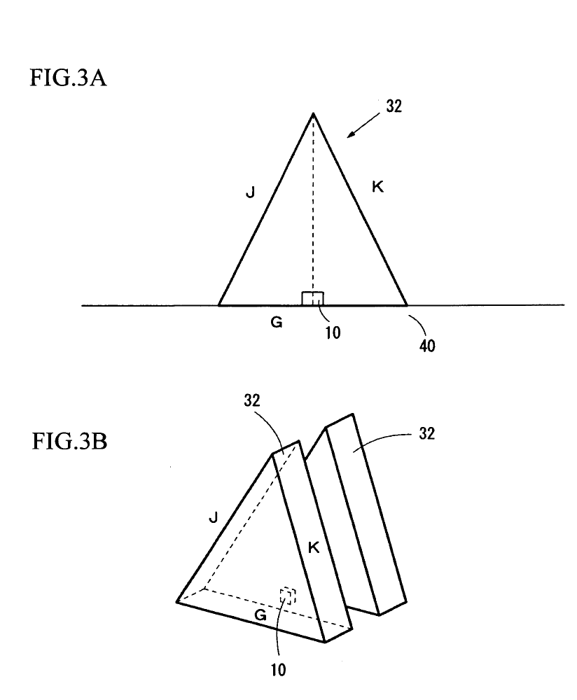

Shields of a second embodiment are shown in FIGS. 3A and 3B. FIG. 3A is a plan view of the shields 32, and FIG. 3B is a perspective view of the shields 32, which sandwich the read-element 10.

The shields 32 of the present embodiment are characterized by the triangular planar shapes. One side “G” of each triangular shield 32 is flush with the air bearing surface 40 of the magnetic head. Each of the shields 30 is line-symmetrically formed in the right-and-left direction (in the core-width direction) with respect to the read-element 10.

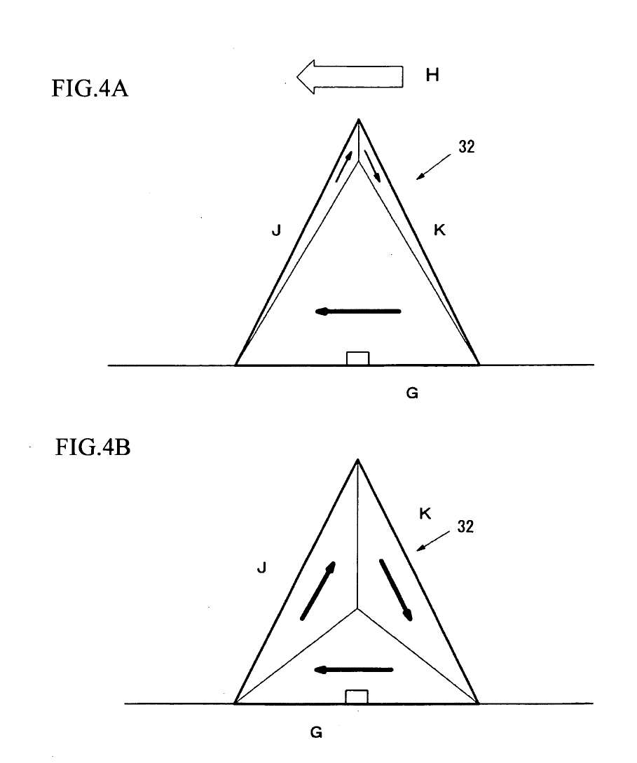

In FIG. 4A, the magnetic field “H” is applied to the shield 32 for magnetization; FIG. 2B shows a magnetic domain structure of the shield 32 when the magnetic field is disappeared. Note that, the magnetic field “H” is applied to the shield 32 as well as the first embodiment.

As shown in FIG. 4A, by applying the magnetic field “H” to the shield 32 having the triangular planar shape, a demagnetizing field, whose direction is opposite to the magnetizing direction, is produced in a corner section defined by sides “J” and “K”. In FIG. 4A, a magnetic wall is formed in the corner section defined by the sides “J” and “K”, and magnetization, whose direction is opposite to the magnetizing direction, is induced.

In the shield 32 having the triangular planar shape, by inducing the magnetization which causes the demagnetizing field, three magnetic domains are induced in the shield 32 and their magnetization directions maintain the demagnetizing field when the magnetizing field is disappeared. The magnetic domain structure of the shield 32 and the magnetization directions of the magnetic domains are shown in FIG. 4B. Since the shield 32 has the triangular planar shape, the magnetic domain corresponding to the read-element 10 is magnetized in the magnetizing direction. In other words, the shield 32 is asymmetrically formed in the vertical direction (the height-direction) with respect to the magnetizing direction, so that the demagnetizing field is slanted and the magnetization directions of the magnetic domains of the shield 32 can be uniquely defined.

In the present embodiment too, by uniquely defining the magnetic domains and the magnetization directions of the shields 32, variation of the magnetization directions of the magnetic domains (the magnetization directions are not uniquely defined). Further, variation of the bias magnetic field working to the read-element 10 can be prevented, so that variation of output signals of the read-element 10 can be prevented. Therefore, characteristics of the magnetic head can be stabilized and production yield of the magnetic head can be improved.

In case of forming the triangular shields 32, conditions of the triangle shape, e.g., apex angles, are not limited. For example, the shields 32 may be asymmetrically formed in the core-width direction. Preferably, the shields 32 is symmetrically formed in the core-width direction with respect to the position of the read-element 10, i.e., isosceles triangle. In this case, a stable magnetic domain structure can be produced.

The present invention is not limited to the GMR type magnetic head and can be applied to magnetic heads, each of which has the shield for magnetically shielding the read-element. For example, the present invention can be applied to MR-type, spin-valve type, GMR type, TMR (Tunneling Magnetoresistance) type and CPP (Current Perpendicular to the Plane)-GMR type magnetic heads.

### (Magnetic Disk Drive Unit)

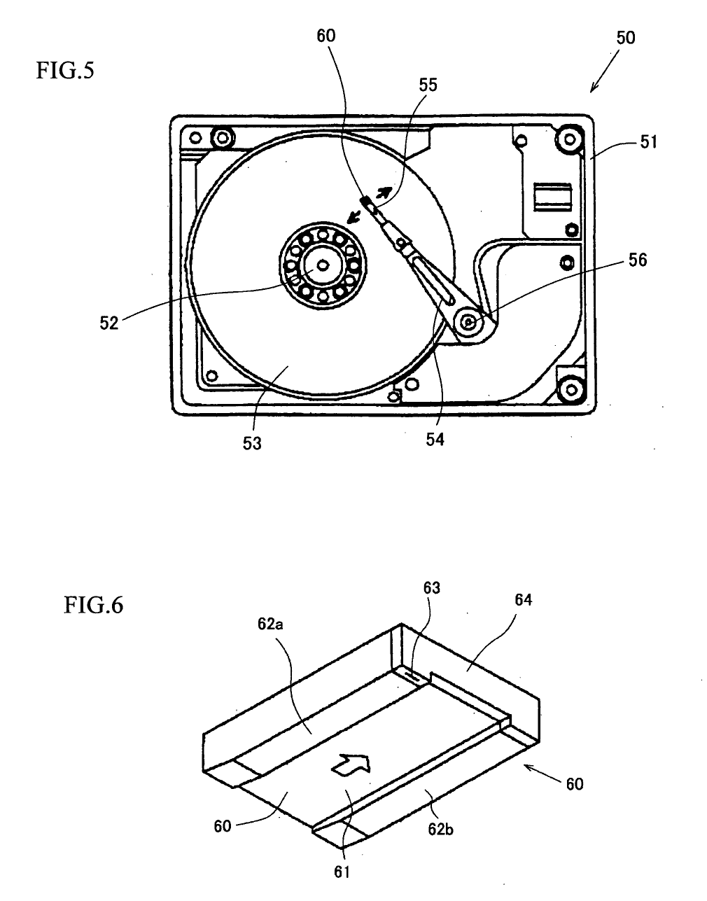

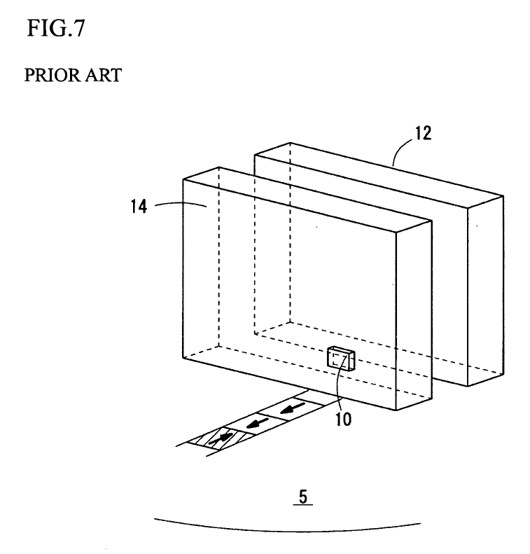

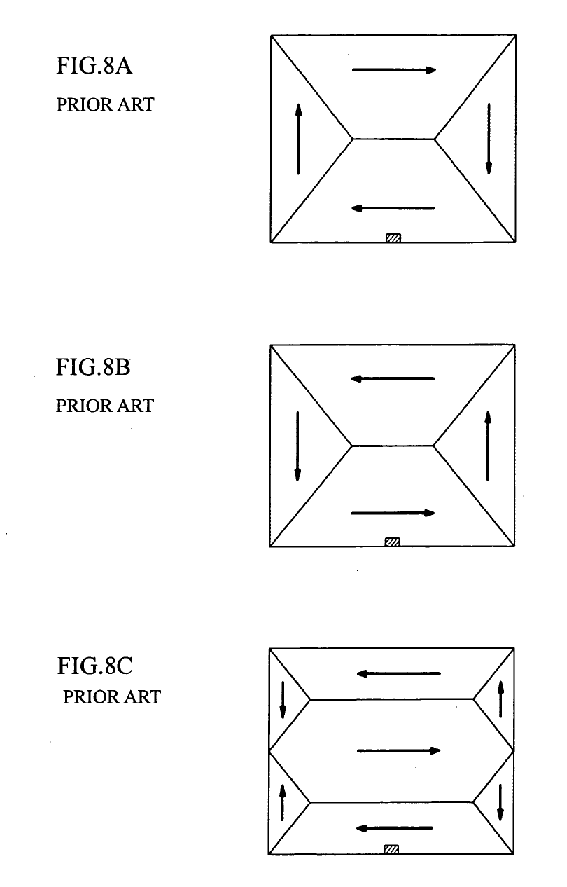

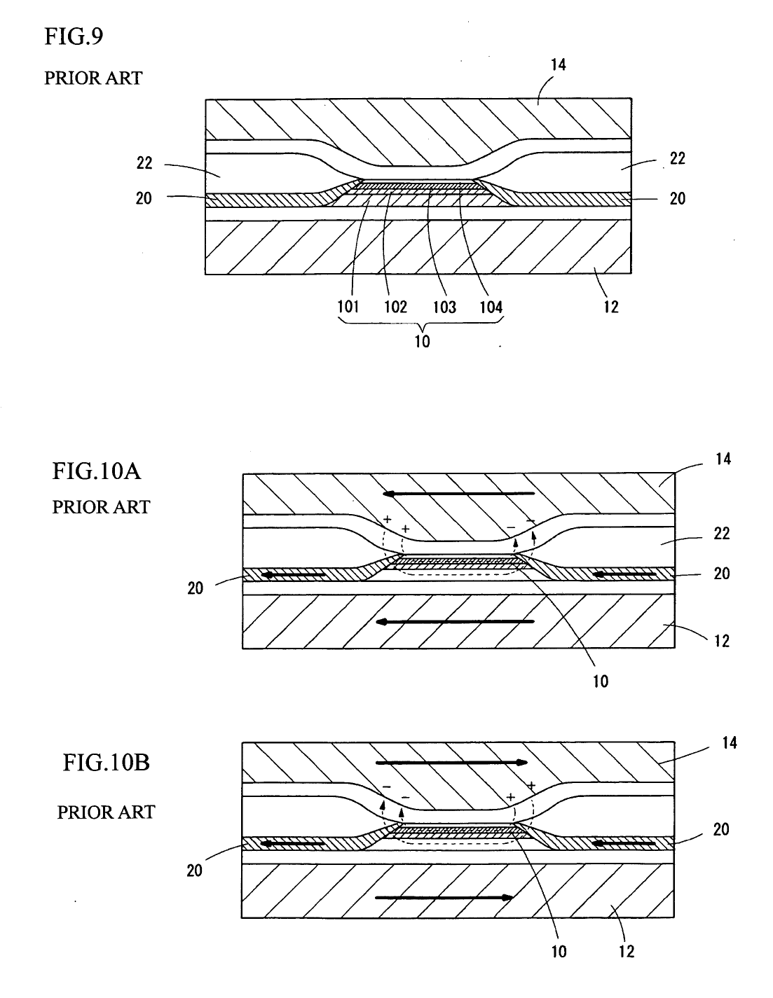

A magnetic disk drive unit, in which the magnetic head of the present invention is attached, is shown in FIG. 5. The magnetic disk drive unit 50 has a box-shaped casing 51 and a magnetic recording disk 53, which is accommodated in the casing 51 and rotated by a spindle motor 52. A carriage arm 54 is provided near by the magnetic recording disk 53 and capable of turning in parallel to the surface of the magnetic recording disk 53. A head suspension 55 is attached to a front end of the carriage arm 54 and extended therefrom. A head slider 60 is attached to a front end of the head suspension 55. The head slider 60 is attached in a face of the head suspension 55 facing the surface of the magnetic recording disk 53.

FIG. 6 is a perspective view of the slider 60. Float rails 62a and 62b, which are formed for floating the head slider 60 from the surface of the magnetic recording disk 53, is formed in an air bearing surface of the head slider 60, which faces the magnetic recording disk 53, along edges of a slider body 61. A magnetic head 63, which includes the shields having the hexagonal or triangular planar shapes, is provided on the front end side of the head slider 60 (on the downstream side of an air stream) and faced the magnetic recording disk 53. The magnetic head 63 is protected by a protection film 64 coating the magnetic head 63.

When the magnetic recording disk 53 is rotated by the spindle motor 52, the head slider 60 is floated from the surface of the magnetic recording disk 53 by the air stream generated by rotation of the magnetic recording disk 53. Then, an actuator 56 performs a seeking action, so that the magnetic head 63 is capable of recording data in and reproducing data from the magnetic recording disk 53.

The invention may be embodied in other specific forms without departing from the spirit of essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A magnetic head,
comprising:
a read-head including a read-element; and
a shield for magnetic-shielding the read-element,
wherein said shield has a hexagonal planar shape, and
one side of said shield is flush with an air bearing surface of said magnetic head.

2. The magnetic head according to claim 1,
wherein said shield is line-symmetrically formed in a core-width direction with respect to a position of the read-element.

3. The magnetic head according to claim 1,
wherein said shield is line-symmetrically formed in a height direction.

4. The magnetic head according to claim 1,
wherein inner angles of corner sections, which are respectively formed in both side faces in a core-width direction, are 170 degrees or less.

5. A magnetic head,
comprising:
a read-head including a read-element; and
a shield for magnetic-shielding the read-element,
wherein said shield has a triangular planar shape, and
one side of said shield is flush with an air bearing surface of said magnetic head.

6. The magnetic head according to claim 5,
wherein said shield is line-symmetrically formed in a core-width direction with respect to a position of the read-element.

7. A magnetic disk drive unit comprising a magnetic head, which has: a read-head including a read-element; and a shield for magnetic-shielding the read-element,
wherein said shield has a hexagonal planar shape, and
one side of said shield is flush with an air bearing surface of said magnetic head.

8. A magnetic disk drive unit comprising a magnetic head, which has: a read-head including a read-element; and a shield for magnetic-shielding the read-element,
wherein said shield has a triangular planar shape, and
one side of said shield is flush with an air bearing surface of said magnetic head.
